(19) United States
(12) Patent Application Publication
(10) Pub. No.: US 2006/0203170 A1
(43) Pub. Date: Sep. 14, 2006

(54) Method of making patterned liquid crystal structure

(76) Inventors: Yingqiu Jiang, Sunnyvale, CA (US); Marvin Ancheta, San Jose, CA (US); Wenhua Niu, San Diego, CA (US)

Correspondence Address: REVEO, INC., 3 WESTCHESTER PLAZA, ELMSFORD, NY, 10523, US

(21) Appl. No.: 11/077,541

(22) Filed: Mar. 10, 2005

(51) Int. Cl. G02F 1/1343

(52) U.S. Cl. 349/142

(57) ABSTRACT

A patterned liquid crystal structure and methods of making such patterned liquid structures is disclosed herein. The structure includes a first and second substrate having a pattern region between the first and second substrate. Liquid crystal material is provided at regions other than the pattern region between the first and second substrate. This is a significant advantage over conventional patterned switchable structures since the contacts are greatly simplified.

### TECHNICAL FIELD

The present invention relates to a method of making patterned liquid crystal structures or displays, particularly non-addressable patterned liquid crystal structure.

### BACKGROUND ART

Liquid crystal structures are desirable for a multitude of applications. One such applications includes liquid crystal based signage or aesthetic structures. These are referred to as patterned liquid crystal displays or structures.

Conventional methods to fabricate patterned liquid crystal displays and windows include use lithography to pattern substrates or electrodes prior to liquid crystal cell filling. However, these methods suffer at least two major drawbacks. First, they require lithographic steps to form patterned substrates or electrodes, an economic limitation. Second, for electrically switchable liquid crystal structures, conductive leads are required to connect the power to each separate electrode section, an obstacle to most since the logos must be modified to use a single conductive lead pattern. This may not be acceptable for users who desire to maintain a pattern without deviating from the intended design.

In the case of PSCT (polymer-stabilized-cholesteric-texture) or PDLC windows, using masks becomes an alternative solution. The masks are used to protect (from the UV radiation) the areas, which are not intended to be polymerized at certain liquid crystal states, and then removed for exposure of the entire area. However, since the liquid crystal mixtures are usually fluorescent during UV radiation, the area under the masks are be partially polymerized.

Therefore, a need remains in the art for improved methods of fabricating patterned liquid crystal structures, and improved patterned liquid crystal structures.

### BRIEF SUMMARY OF THE INVENTION

A patterned liquid crystal structure and methods of making such patterned liquid structures is disclosed herein. The structure includes a first and second substrate having a pattern region between the first and second substrate. Liquid crystal material is provided at regions other than the pattern region between the first and second substrate. This is a significant advantage over conventional patterned switchable structures since the contacts are greatly simplified.

### BRIEF DESCRIPTION OF THE FIGURES

The foregoing summary as well as the following detailed description of preferred embodiments of the invention will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings, where:

FIG. 1 is a side view of a patterned liquid crystal structure;

FIG. 2 is surface view of a patterned liquid crystal structure;

FIG. 3 is surface view of a patterned liquid crystal structure wherein the liquid crystal is in a transformed optical state;

FIG. 4 is a patterned liquid crystal structure, whereby the pattern material in its current state is visible and has an outline within the liquid crystal;

FIG. 5 shows the cell of FIG. 4 in the transformed state;

FIGS. 6-8 show operational modes of the patterned liquid crystal structures of the present invention; and

FIG. 9-18 illustrate steps of making the patterned liquid crystal structures of the present invention.

### DETAILED DESCRIPTION OF THE FIGURES

The present invention provides a solution of making patterned liquid crystal structures in an economic way while maintaining the authentication of the patterns.

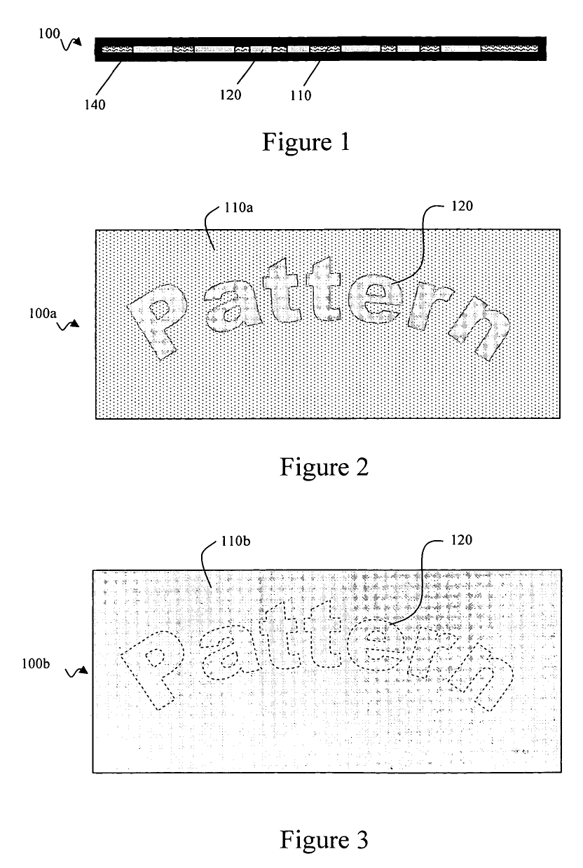

Referring now to FIG. 1, shown is a side view of a patterned liquid crystal structure 100. Accordingly, contained within the patterned liquid crystal structure 100 is one or more substrate layer(s) 140. Further positioned within the patterned liquid crystal structure 100 is liquid crystal material 110. Also positioned within the patterned liquid crystal structure 100 is pattern material 120.

Referring now to FIG. 2, illustrated is a surface view of a patterned liquid crystal structure 100 in a state whereby a pattern 120 is recognizable within one or more liquid crystal region(s) 110a. The pattern 120 may be any arbitrary pattern, such as a design, artwork, a logo, text, illusion pattern, or any other pattern.

Referring now to FIG. 3, a surface view of a patterned liquid crystal structure 100 is shown wherein the liquid crystal is in a transformed optical state. Note that while the pattern 120 within the panel is shown with dashed lines, this pattern 120 may blend completely with the liquid crystal 110b material in the transformed optical state, thereby becoming virtually invisible.

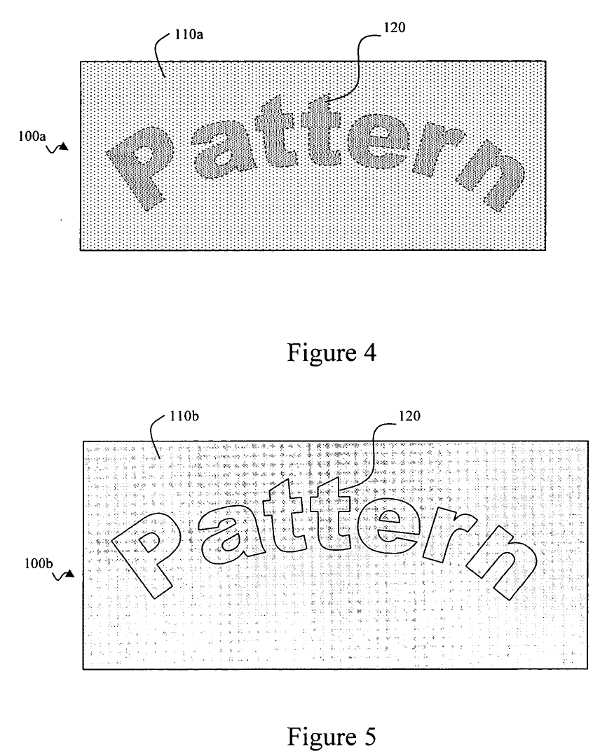

Referring now to FIG. 4, shown is a patterned liquid crystal structure 100, whereby the pattern material 120 in its current state is visible and has an outline within the liquid crystal material 110. Additionally, as shown in FIG. 5, in the transferred state the outlined image of the pattern material 120 is indistinguishable from the liquid crystal material 110b.

The pattern material 120 may be any material capable of preventing liquid crystal material 110 from leaching out of its designated area on the substrate 140.

The liquid crystal material 110 may be any liquid material capable 110 of transforming its optical state upon activation. For example, liquid crystal materials including but not limited to dynamic scattering, twisted nematic, supertwisted nematic, dichroic, smectic A, ferroelectric, cholesteric liquid crystals (CLC), polymer dispersed liquid crystal (PDLC) and polymer stabilized cholesteric texture (PSCT) may be used as the liquid crystal material 110.

The substrate may be glass or plastic. In the case of electrically switchable liquid crystal structures, the substrate may include glass or plastic with suitable optically transparent electrode materials, such as, indium tin oxide, tin oxide, or any other suitable transparent conductor. Further, where one is reflective, the electrode may comprise any suitable metal electrode material.

In transforming the optical state of the liquid crystal material 110 it may be accomplished by electrical activation, optical activation, heat activation, pressure activation, or any other driving force suitable to change liquid crystal material 110 from one state to another. Further, the optical properties of the liquid crystal material 110 may vary with viewing angle, whereas the optical properties of the pattern region does not.

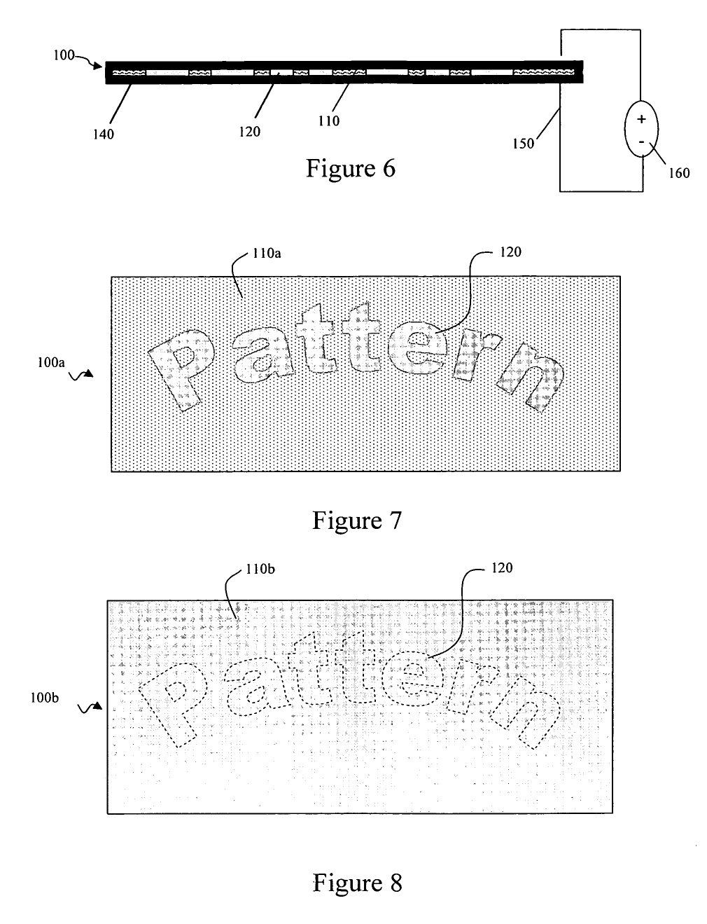

Referring now to FIG. 6, depicted is a side view of an electrically switchable patterned liquid crystal structure 100. Arranged on the outside of the electrically switchable patterned liquid crystal structure 100 is one or more electrode layer(s) 150, which receives a charge from a power source 160. Further positioned within the electrode layers 150, is liquid crystal material 110. Also positioned within the electrode layers 150 is pattern material 120.

Referring now to FIG. 7, depicted is a surface view of an electrically switchable patterned liquid crystal structure 100 in a state whereby the pattern material 120 is recognizable within one or more liquid crystal region(s) 110a. The liquid crystal region(s) 110 will remain in this abeyant state until the electrode layer 150 renders an electrical charge against the liquid crystal material 110.

Referring now to FIG. 8, depicted is a surface view of an electrically switchable patterned liquid crystal structure 100 wherein the liquid crystal 110b is in a transformed optical state. In this transferred optical state the liquid crystal area 110b takes on substantially the same optical properties of the patterned area 120, blending completely with the patterned area 120, thereby rendering the patterned area 120 indistinguishable. Note that the electrically switchable patterned liquid crystal structure 100 may include any pattern, including a solid pattern (e.g., as in FIGS. 2-3), or an outline pattern (e.g. as in FIGS. 4-5).

In a preferred embodiment of the electrically switchable patterned liquid crystal structure 100, in the off position the pattern material 120 and liquid crystal material 110 are visibly opaque. However, upon electrical activation the liquid crystal material 110 becomes transparent, thereby allowing the image of the pattern material 120 to become visible. In yet another embodiment of the electrically switchable patterned liquid crystal structure 100, in the on position the pattern material 120 and liquid crystal material 110 are visibly opaque. Accordingly, upon withdrawal of electricity the liquid crystal material 110 becomes transparent, thereby allowing the image of the pattern material 120 to become visible.

The pattern material 120 may be any insulating material capable of preventing liquid crystal material 110 from leaching out of its designated area on the substrate 140. Furthermore, the liquid crystal material 110 may be any electrically switchable liquid crystal material capable 110 of transforming its optical state upon activation.

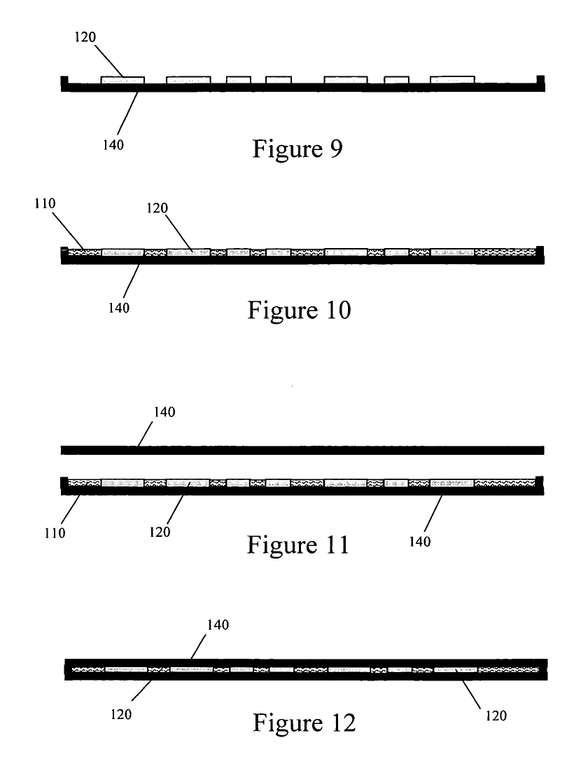

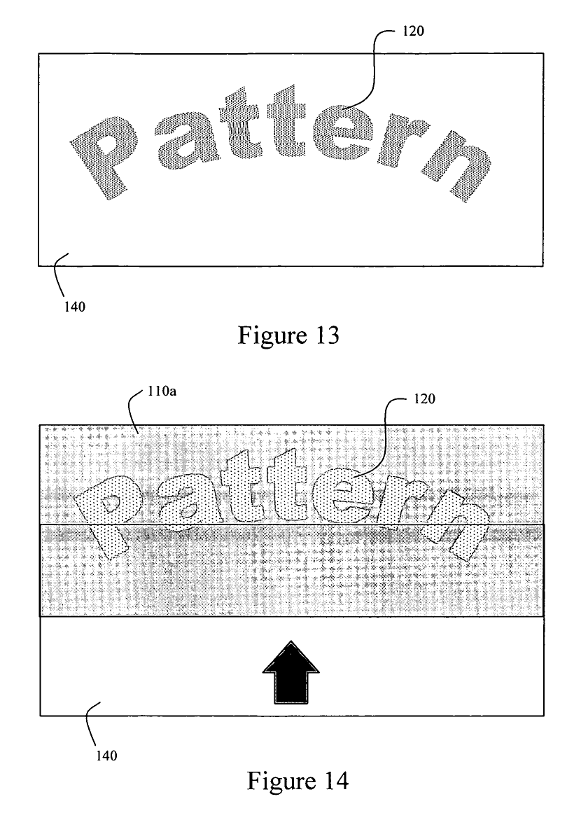

Referring now to FIGS. 9-12, illustrated is a method of making patterned liquid crystal structures 100. In FIGS. 9 and 13, shown is a substrate 140, whereby patterned material 120 is added to the top of the substrate 140, as aforementioned any patterned material may be used. Subsequently, shown in FIG. 10, liquid crystal material 110 will be added to regions of the substrate 140 where pattern material 110 has not been added. Following the addition of the liquid crystal material 110, and as shown in FIGS. 10 and 14 another substrate is placed on top of the patterned material 120 and liquid crystal material 110. Thus a patterned liquid crystal structure 100 is formed with patterned material 120 and liquid crystal material 110 located between a bottom substrate 140 and a top substrate 140. Following the inclusion of the top substrate 140 the patterned liquid crystal structure is laminated.

In one embodiment of making patterned structures or windows, screen-printable, UV curable pressure-sensitive (PSA) adhesive 120 is used along with liquid crystal 110. In certain preferred embodiments, the liquid crystal material comprises PSCT or PDLC materials. In addition to serving as a pattern template, the pattern material 120 serves as an insulation layer during the UV polymerization. A pressure sensitive adhesive pattern 120 may be applied with a silk screen process, for example, wherein a positive image pattern or logo is utilized. Subsequently, the pressure sensitive adhesive pattern 120 may be screen-printed on to the substrate. In producing the substrate (e.g., ITO coated glass or plastic), it can be cleaned in an ultrasonic bath or wiped with a lint-free (IPA) soaked cloth. In certain embodiments, glass spacers may be sprayed onto one or both of the substrates. Following the inclusion of the pressure sensitive adhesive pattern 120, the print then may be radiated with a light source (e.g., a UV source) to cure the adhesive pattern material. Then liquid crystal 110 is subsequently added to the substrate 140 where the pattern 120 is not positioned. In one embodiment the liquid crystal mixture 110 is dispensed (e.g., with glass spacers) over the bottom substrates 140, e.g., using a knife coater or a Meyer rod applicator.

A top substrate 140 is coupled to the bottom substrate 140. In certain embodiments, both substrates may be routed through a laminator where both substrates 140 will be laminated (preferably ITO coated plastic). Accordingly, the pressure will be adjusted to squeeze out the liquid crystal 110 and to seal the top substrate 140 with the bottom substrate 140 by means of the pressure sensitive adhesive pattern 120. Consequently, the liquid crystal remains within the spaces not occupied by pressure sensitive adhesive pattern 120.

During the abeyant state the pressure sensitive adhesive patterned area 120 and liquid crystal area 110 are opaque (e.g., milky white), however, upon activation the state of the liquid crystal area 110 changes from opaque to transparent, thereby showing the pressure sensitive adhesive patterned image.

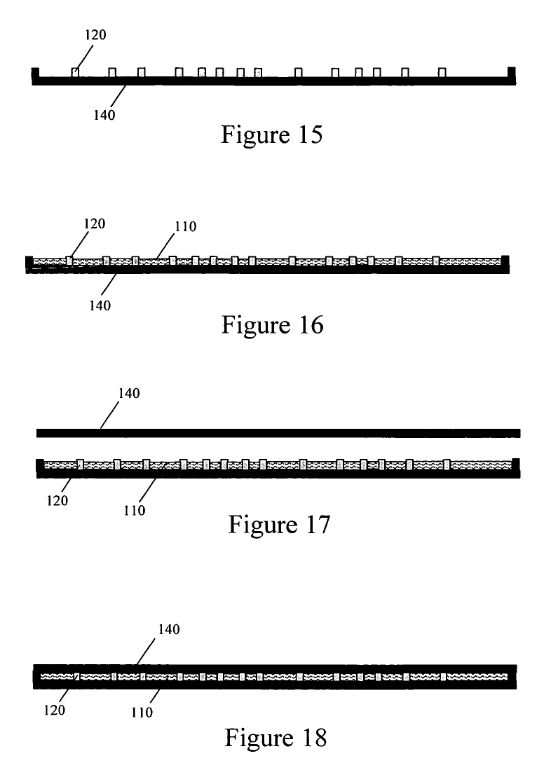

Referring now to FIGS. 15-18, shown is a method of making patterned liquid crystal structures 100, whereby the pattern material 120 is applied in such a way as to produce an outline of and image or logo. First the substrate 140 is positioned at the bottom. Accordingly, a fine amount of pattern material is added to the substrate 140. Subsequently, liquid crystal material 110 is added to the portion of the substrate 140 where patterned material 120 is not located. Afterwards, a top substrate 140 portion is positioned on top of the pattern material 120 and liquid crystal material 110. Lastly, the entire patterned liquid crystal structure 100 is laminated.

As shown in FIGS. 4 and 5, depicted is a surface view of a switchable patterned liquid crystal structure 100, whereby the pattern material 120 is applied in such a way as to produce an outline of a pattern 140. Accordingly, as shown in FIG. 4 the switchable patterned liquid crystal structure 100 is in an optical transformed state wherein the outlined pattern 140 is distinguishable from the liquid crystal material 110. Further shown in FIG. 5, depicted is a switchable patterned liquid crystal structure 100, wherein the liquid crystal material 110 is not in a optical transformed state, thereby rendering the pattern material 120 indistinguishable, hence eliminating the outlined pattern image 120.

It is understood that the printing technique used may include, but is not limited to, ink-jet printing, bubble jet printing, laser printing, flexo press printing, off-set printing, gravure printing and serigraphy (silk screen printing). Any printing technique suitable to print a pattern having a thickness approximate that of the cell gap may be used.

Furthermore, the pattern region 120 may be formed of dispensable adhesive material, polymer material dispensed into pattern form, pre-cut material and/or contiguous strips. Accordingly, the contiguous strips may adhere to one of both substrates with adhesive material, material fasteners or pressure maintained between substrates.

This method and structures described herein employs traditional patterning (e.g., printing) technology liquid crystal technology. Various polymer liquid crystal technology structures are described, e.g., in U.S. Ser. No. 09/958,459 filed Oct. 5, 2001 entitled “Electro-Optical Glazing Structures Having Scattering and Transparent Modes of Operation”, and PCT/US03/24515 filed Aug. 4, 2003 entitled “Flexible Electrically Switchable Glazing Structure and Methods of Forming Same”, both of which are incorporated by reference herein).

### EXAMPLE

The following non-limiting example describes a PSCT based liquid crystal structure, however, as described herein, the present invention may also find application in pother liquid crystal material technologies.

A patterned PSCT window was formed with a screen-printable, UV curable pressure-sensitive (PSA) adhesive. The PSA (SP-7514 from Minnesota Mining and Manufacturing, St. Louis, Mo.) serves as an insulation layer during the UV polymerization as well as providing the pattern. A silk screen with a positive image pattern or logo was utilized. Subsequently, the pressure sensitive adhesive pattern was screen-printed on to the ITO substrate. The ITO glass substrate was prepared by cleaning in an ultrasonic bath. Alternatively, the ITO glass substrate may be wiped with a lint-free (IPA) soaked cloth. Glass spacers were sprayed onto one or both of the substrates. Following the inclusion of the PSA pattern, the print is then radiated with a UV source to cure the adhesive pattern material. Then PSCT liquid crystal material included 30 micron diameter glass spacers in a percentage of 0.2% by weight. The mixture is dispensed to the substrate using a knife coater or a Meyer rod applicator.

The resultant structure was 5 inches by 7 inches. A voltage of 80V was applied across the electrodes and the panel was then cured under UV light (2 mw/cm2) for 30 minutes. After curing the pattern remained transparent while the non-patterned areas were switched between transparent and opaque states.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. The patterned liquid crystal structure as in claim 13, further comprising
a second substrate;
wherein the pattern region is between the first and second substrate; and
wherein the liquid crystal material is at regions other than the pattern region between the first and second substrate.

2. The patterned liquid crystal structure as in claim 13, wherein the pattern material is polymer material.

3. The patterned liquid crystal structure as in claim 13, wherein the pattern material is contiguous strip.

4. The patterned liquid crystal structure as in claim 3, wherein the contiguous strip adheres to one or both substrates with dispensable adhesive material.

5. The patterned liquid crystal structure as in claim 3, wherein the contiguous strip adheres to one or both substrates with mechanical fasteners.

6. The patterned liquid crystal structure as in claim 3, wherein the contiguous snip maintains pressure between substrates.

7. The method of claim 14, further comprising:
adhering a second substrate over the liquid crystal material and the pattern region.

8. The method has in claim 14, wherein the pattern material is polymer material.

9. The method has in claim 14, wherein the pattern material is contiguous strip.

10. The method has in claim 9, wherein the contiguous strip adheres to one or both substrates with dispensable adhesive material.

11. The method has in claim 9, wherein the contiguous strip adheres to one or both substrates with mechanical fasteners.

12. The method has in claim 9, wherein the contiguous strip maintains pressure between substrates.

13. A patterned liquid crystal structure comprising:
a pattern region on a first substrate; and
liquid crystal material at regions other than the pattern region on the first substrate.

14. A method of making a patterned liquid crystal structure comprising:
depositing a pattern material on a first substrate to form a pattern region; and
dispensing liquid crystal material on the first substrate at regions other than the pattern region.

15. (canceled)

16. (canceled)

17. The patterned liquid crystal structure as in claim 13, wherein the pattern region comprises pressure sensitive adhesive material.

18. The method as in claim 14, wherein the pattern material comprises pressure sensitive adhesive material and wherein depositing comprises screen printing.
